(19) United States
(12) Patent Application Publication
(10) Pub. No.: US 2006/0190350 A1
(43) Pub. Date: Aug. 24, 2006

(54) Systems and methods for finding, presenting and selling compatible goods

(76) Inventor: Eric Maas, Salt Lake City, UT (US)

Correspondence Address: FENWICK & WEST LLP, SILICON VALLEY CENTER, 801 CALIFORNIA STREET, MOUNTAIN VIEW, CA, 94041, US

(21) Appl. No.: 11/359,710

(22) Filed: Feb. 21, 2006

Related U.S. Application Data
(60) Provisional application No. 60/656,133, filed on Feb. 23, 2005.

(51) Int. Cl. G06Q 30/00

(52) U.S. Cl. 705/26

(57) ABSTRACT

An system for finding, presenting and selling compatible products includes: a pricing guide module, an affiliates module, a marketplace listing module, a trade-in website module, a transaction processing module, an inventory handling module, a database, and compatibility reference files. The compatibility input module is used to receive and store compatibility information for various goods. Using the input data, marketplace listing module creates products listing that are augmented with additional compatibility information. The product compatibility website module cooperates with the marketplace manager to interact with the client devices and provide compatible products. The product compatibility website module interacts with the user via a client device to input criteria and find compatible items and select them for purchase. The transaction processing module interacts with the user to process and complete the transaction by processing payment information, arranging for delivery of the purchased compatible item, and updating the inventory database. The present invention also includes a novel method for performing product compatibility searches and completing online transactions.

### CROSS-REFERENCES TO RELATED APPLICATIONS

The present application claims priority under 35 U.S.C. § 119(e) to U.S. Provisional Patent Application No. 60/656,133, filed on Feb. 23, 2005, entitled “Product Compatibility Finder” which is incorporated by reference in its entirety.

### BACKGROUND OF THE INVENTION

1. Field of the Invention

The present invention relates to systems and methods for executing the sale and purchase of goods in an on-line market place. In particular, the present invention relates to systems and method for finding, presenting and selling goods in an on-line marketplace.

2. Description of the Background Art

The use and proliferation of the Internet for purchasing and selling goods and services is well known. With that advent of eBay® and other online auctions or marketplaces, there has been tremendous growth in the number and dollars amount of goods being sold and purchased over the Internet. In such transactions, a seller must create and post a listing including a description of the goods to be sold, a reserve price, and other information. This process can be time consuming and has not been fully automated.

For online marketplaces such as eBay, sellers selling product where compatibility is a concern, there is not a way to find and cross market compatible goods. Most sellers have resorted to including all of the compatible products in the description of the item for sale, creating an unattractive, difficult to read and often inaccurate list of information. In some cases, this increases the number of refunds and exchanges because the products are not accurately categorized for compatibility. Alternatively sellers are leaving the information out altogether and letting the buyer figure it out on their own, which results in significant customer service problems.

Therefore, what is needed is automated systems and method for finding, presenting and selling compatible goods in an online marketplace.

### SUMMARY OF THE INVENTION

The present invention overcomes the deficiencies and limitations of the prior art by providing a product compatibility system. In one embodiment, the product compatibility system comprises: a pricing guide module, a compatibility input module, a marketplace listing module, a product compatibility website module, a transaction processing module, an inventory module, a database, a marketplace manager, a product compatibility reference files, and a SKU compatibility file. The marketplace manager creates a product compatibility system that accesses the other modules to find, present and sell compatible products. In particular, the compatibility input module is used to receive and store compatibility information for various goods. Using the input data, marketplace listing module creates products listing that are augmented with additional compatibility information. The product compatibility website module cooperates with the marketplace manager to interact with the client devices and provide compatible products. The product compatibility website module interacts with the user via a client device to input criteria and find compatible items and select them for purchase. The transaction processing module interacts with the user to process and complete the transaction by processing payment information, arranging for delivery of the purchased compatible item, and updating the inventory database. The present invention also includes a novel method for performing product compatibility searches and completing online transactions.

### BRIEF DESCRIPTION OF THE DRAWINGS

The invention is illustrated by way of example, and not by way of limitation in the figures of the accompanying drawings in which like reference numerals are used to refer to similar elements.

FIG. 1 is a block diagram of a general system including the product compatibility system of the present invention.

FIG. 2 is a block diagram of a first embodiment of the product compatibility system of the present invention.

FIG. 3 is a block diagram of a second embodiment of the product compatibility system of the present invention.

FIG. 4 is a block diagram of a memory of the product compatibility system in accordance with the second embodiment of the present invention.

FIG. 5 is a flowchart of a first embodiment of a method for finding, presenting and selling compatible products in an online marketplace according to the present invention.

FIG. 6 is a flowchart of a second embodiment of a method for finding, presenting and selling compatible products in an online marketplace according to the present invention.

FIG. 7 is a graphical representation of an exemplary interface for inputting data regarding compatibility according to the present invention.

FIG. 8 is a graphical representation of an exemplary interface for inputting compatibility data, finding compatible goods and displaying an order of compatible goods according to the present invention.

FIG. 9 is a graphical representation of another exemplary interface for inputting compatibility data, finding compatible goods and displaying an order of compatible goods according to the present invention.

### DETAILED DESCRIPTION OF THE PREFERRED EMBODIMENTS

System and methods for finding, presenting and selling compatible items in an on-line market place are described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention. For example, the present invention is described primarily with reference to product compatibility for computers and electronics. However, the present invention applies to any type of goods or services in an on-line marketplace.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

Moreover, the present invention claimed below is operating on or working in conjunction with an information system or network. The present invention is capable of operating with any information system from those with minimal functionality to those providing all the functionality disclosed herein.

Overview

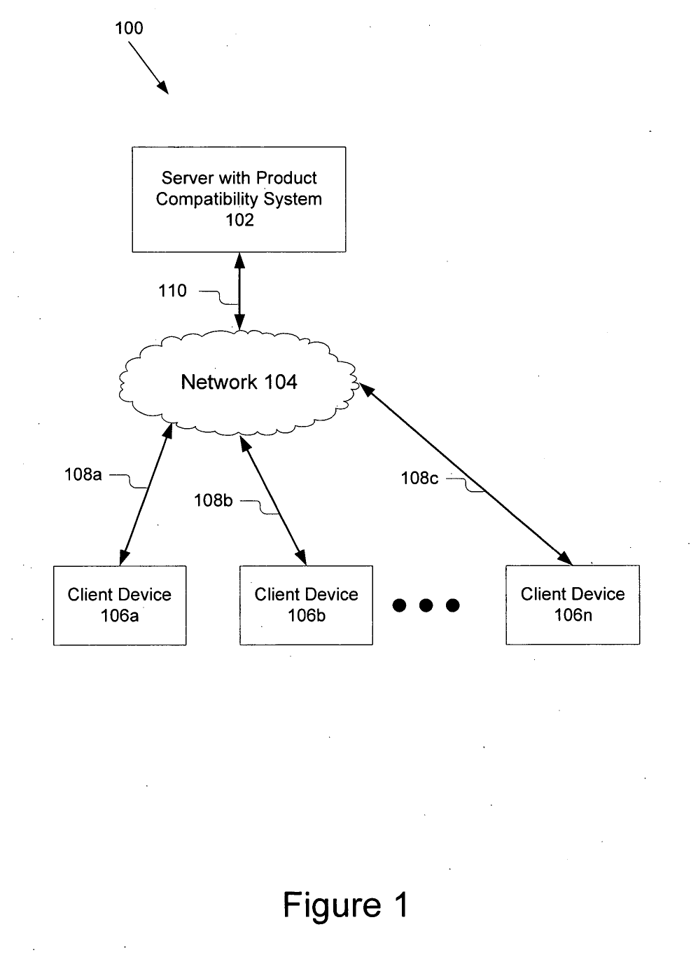

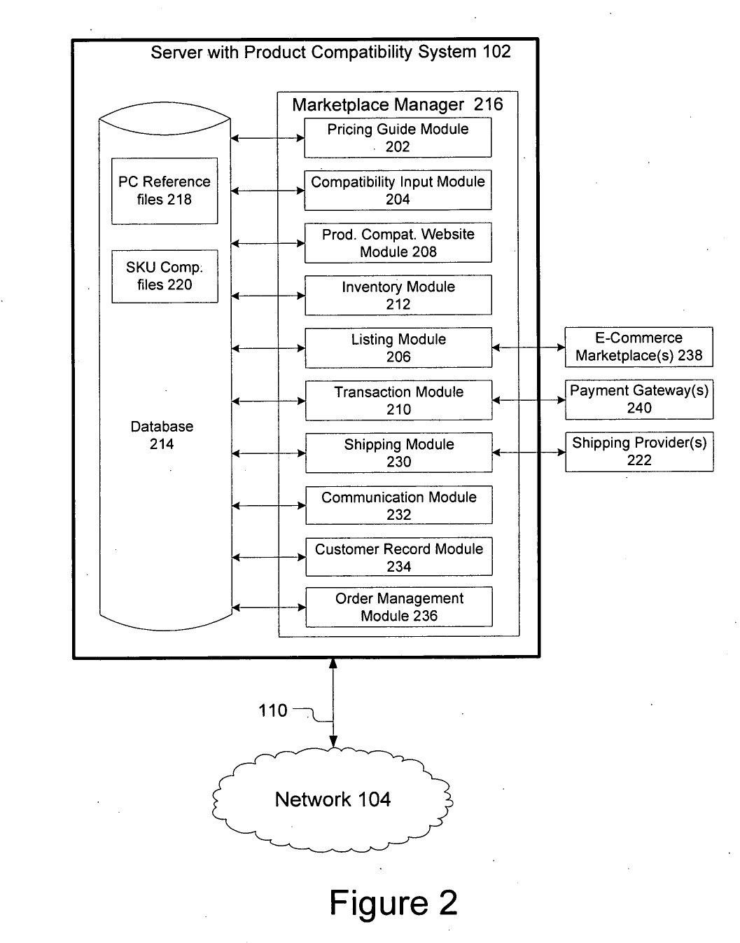

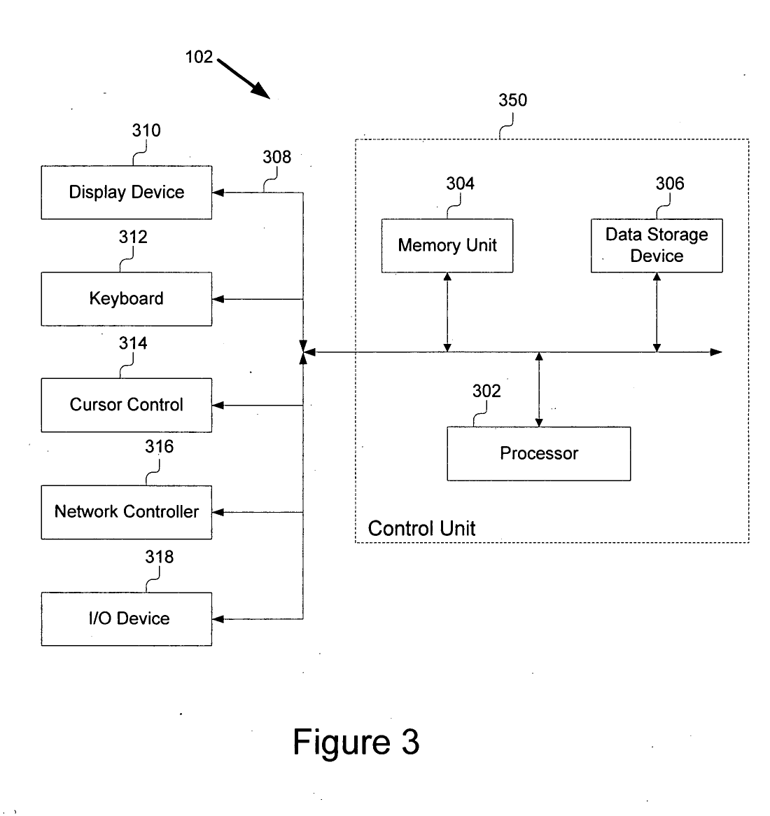

Referring now to FIG. 1, a first embodiment of a system 100 such as an online market place and including a product compatibility system 102 of the present invention is shown. In this first embodiment, the system 100 comprises: a server including the product compatibility system 102, a network 104, and a plurality of a client devices 106a-n. The server 102 is a conventional type of web server, but also includes the product compatibility system of the present invention as will be described in detail below with reference to FIGS. 2 and 3. The server 102 is coupled by a signal line 110 to the network 104. The network 104 is a conventional type such as the Internet, a local area network (LAN), a wide area network (WAN). The network 104 couples the server 102 to client devices 106a-n for communication and to consummate transactions between the client devices 106a-n and the product compatibility system 102. The network 104 is coupled to the plurality of client devices 106a-n by respective signal lines 108a-n. The client devices 106a-n can be personal computers, personal digital assistants, thin-client interface terminals or other devices that enable communication to the server 102.

The system 100 advantageously allows users to buy and sell goods in online market places or as direct transactions from online sellers to buyers. The present invention enhances the existing marketplaces and online transactions by providing an easy and automatic way for sellers to accept and buyers to submit used goods or articles including compatibility information, and to allow users to find or automatically suggest compatible items. Those skilled in the art will recognize that the system 102 of the present invention can be used alone without an online marketplace or transaction, but will be disclosed below in the context of on-line marketplace. The system 102 of the present invention is particularly advantageous because it facilitates the sourcing and buying of used merchandise (compatible items) from end users (tradees) for merchants. The ease in finding, automatically presenting or suggesting compatible items is advantageous because it can be a significant increase in sales volume due to automation and ease of use for the user. Giving tradees the ability to locate additional items that are compatible either with what they already own or are purchasing is a significant opportunity to generate additional sales. Moreover, allowing buyers to quickly and easily find additional product is yields higher average sale prices, increased customer satisfaction, and improved repeat buying rates.

System

Referring now to FIG. 2, a block diagram of a first embodiment of the product compatibility system 102 of the present invention is shown. The first embodiment of the product compatibility system 102 is preferably a server including: a pricing guide module 202, a compatibility input module 204, a listing module 206, a product compatibility website module 208, a transaction module 210, an inventory module 212, a database 214, a marketplace manager 216, product compatibility reference files 218, SKU compatibility files 220, a shipping module 230, a communication module 232, a customer record module 234 and an order management module 236. As illustrated in the first embodiment of the product compatibility system 102, some modules may be in communication with software systems operating outside of the server including: the listing module 206 may be in communication with e-commerce marketplace(s) 238, the transaction module 210 may be in communication with payment gateway(s) 240, the shipping module 230 may be in communication with shipping provider(s) 242, and the communication module 212 may be in communication with customer via the network 104.

The marketplace manager 216 is an application program that controls and is coupled to the other modules 202, 204, 206, 208, 210 and 212 of the system 102. The marketplace manager 216 is the application that the merchant uses to facilitate and manage the selling of his/her items. The term, merchant, is used generally herein, and includes an individual personally selling one product, all the way across the spectrum to a mass-market retailer. The marketplace manager 216 also manages the product compatibility location and presentation process.

In preparation for adding product compatibility information and selling compatible products, the pricing guide module 202 creates an inventory of “tradable” items. This comprises, at its most basic level, a SKU#, a description, images, and base price (price paid for item) for each tradable item. If there are specific attributes (such as condition, size, etc.) that effect the value of the item, these items can be set up for dynamic pricing based on a series of price adjustment files also uploaded to the system 102. Additionally, pricing information can be sourced dynamically for any number of 3^{rd} party sources. All of this product pricing information is stored in the database 214 and is accessible by the marketplace manager 216.

The compatibility input module 204 is used to augment the data provided by the pricing guide module 202. In addition to the information provided by the pricing guide module 202, sellers or third parties input compatibility information corresponding to products using the compatibility input module 204. The product compatibility information can be associated with a SKU or made particular to a specific product. The compatibility information includes a list of associations between base products and compatible products. For example, the compatibility information includes the linking of a reference file to an SKU file. The compatibility input module 204 is coupled to the database 214 to upload this information into the database 214. The compatibility input module 204 is also used to input data that forms the reference file 218.

The listing module 206 is used to facilitate providing one or more listings in e-commerce marketplace listing(s) 238, with an exemplary e-commerce marketplace comprising eBay®. Application programming interfaces (APIs) are used to directly interface with available e-commerce marketplaces. When a listing is launched on an e-commerce marketplace, all pertinent inventory information is passed, along with listing parameters, to the marketplace. While a listing is live, the listing module 206 performs the function of listing monitoring, which involves periodically checking the status of the listing, including the current bid price in the case of an auction marketplace. If the current bid is under the threshold amount and a defined stage in the selling process has been reached (e.g., a defined time before the close of a bidding process), then the communication module 232 will be invoked to notify, as described below. At the end of the listing duration, the e-commerce marketplace can notify the listing module 206 with the final status and all pertinent order information. The listing module 206 is also used to provide listings with the added functionality of including product compatibility information in marketplace listings. By combining the client-created price guide information, with flash programming, the listing module 206 generates marketplace listings that can include product compatibility information. Price guide and product compatibility information is made available in real-time to customers browsing items for sale by the same vendor (or affiliates) by communication between the listing module 206, the pricing guide module 202 and the compatibility input module 204. The addition of compatibility input module 204 has shown to be effective for marketing items that are for sale and related to buyers pending purchases.

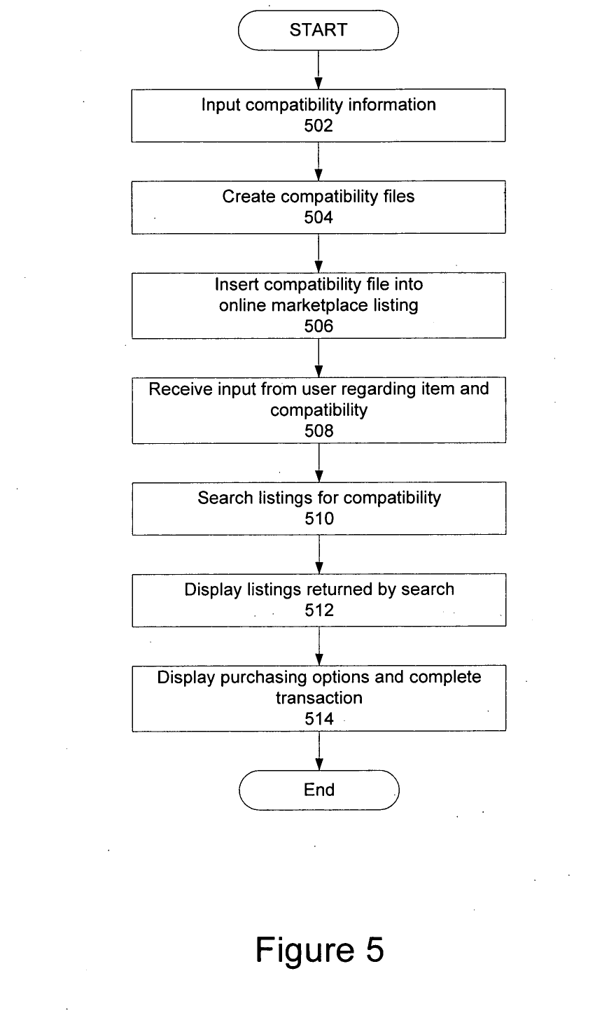

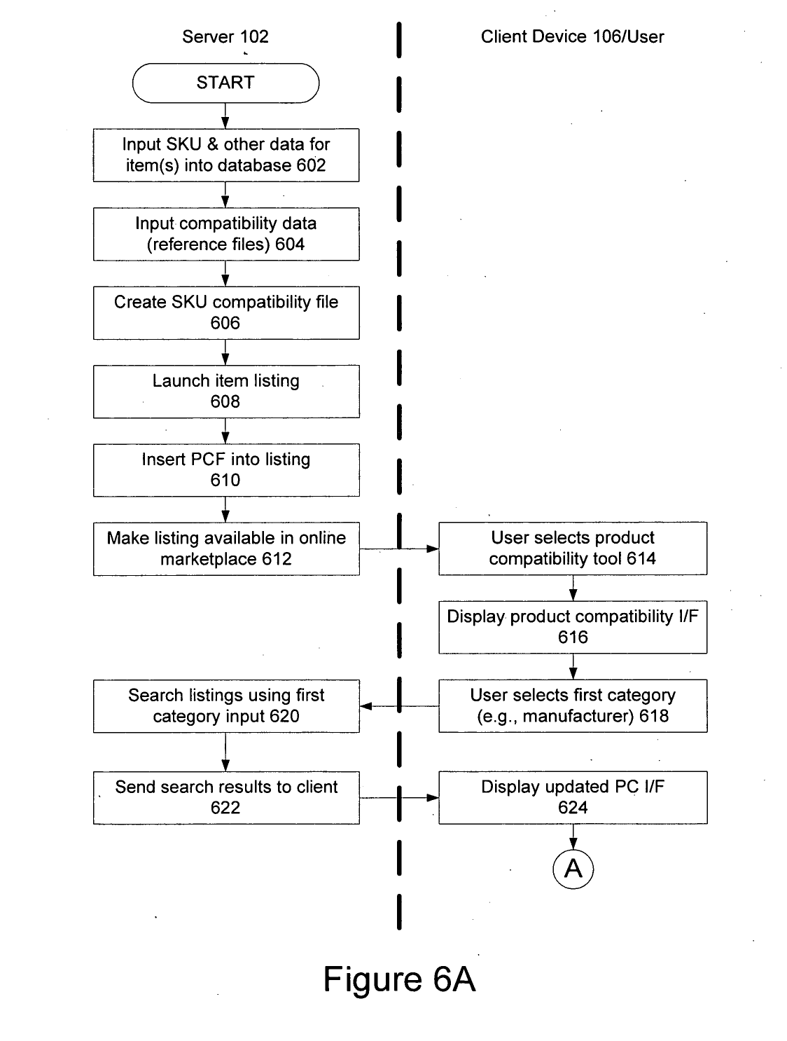

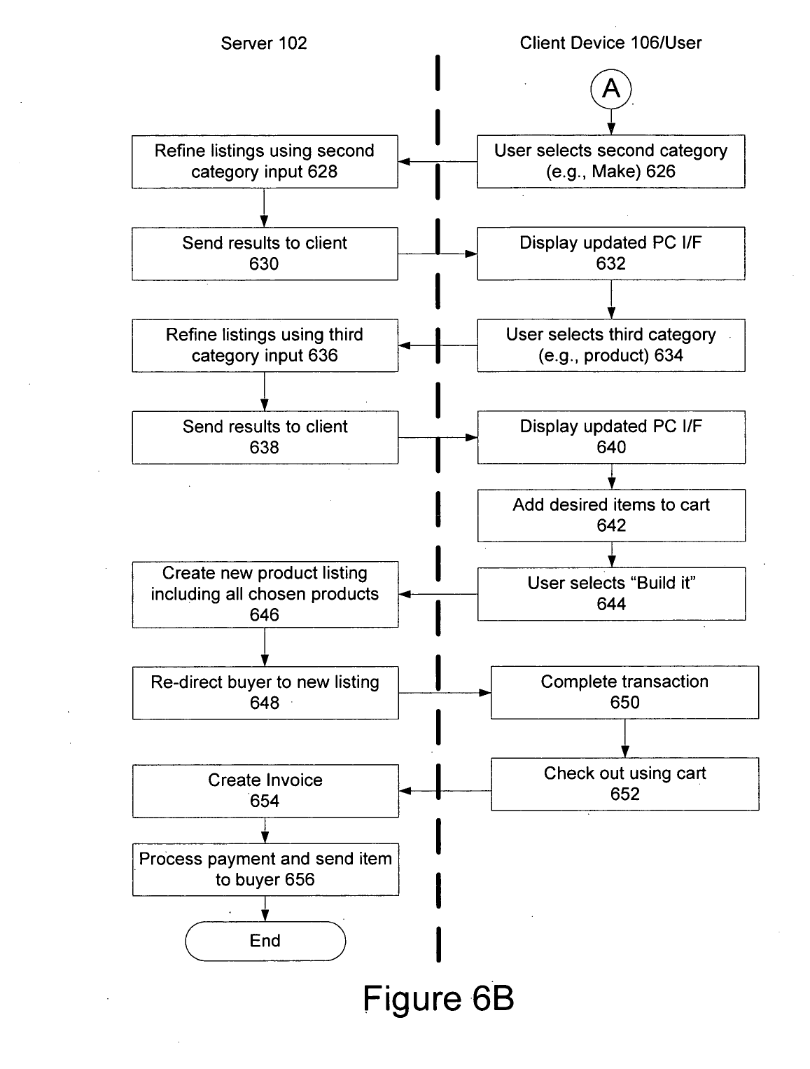

The product compatibility website module 208 is used to create customer facing website that allows users to view items compatible with input parameters, or pending purchases, as well as shop for normal for-sale merchandise. Within the product compatibility area, the customer reviews product information for compatible products and can completes a transaction as specified below. This is a usually a custom designed website, but may also be a standard, template-driven site. The product compatibility website module 208 also communicates with the client device 106 to present user interfaces and data, perform searches and filtering responsive to user input perform other actions as described in more detail below with reference to FIGS. 5 and 6.

The transaction module 210 accepts input from the user and creates the interfaces to specify compatible goods, present pricing, create inventory records and processes other information required to complete the transaction. For example, a trader navigates to the base product, uses the compatibility system 102 to locate a product they are interested in purchasing. This item is added to the cart and the trader can “checkout” or search for additional items to purchase. Upon check out, the transaction processing module completes the transaction, and notifies the inventory module 212 to update the inventory and deliver the item ordered. The processing of payment information can also be done by the transaction processing module 210 via direct API integrations. The transaction module 210 interfaces with payment gateway(s) 240. Such payment gateway(s) may include services such as PayPal, Verisign, CardService International, Authorize.net, ProPay and the like.

The inventory module 212 is responsible for additional processing once an item has been purchased. The inventory module 212 also signals the marketplace manager 216 to process payment, updates recording of inventory, and provides information to a backend process responsible for sending the item to the customer and tracking delivery and acceptance. The inventory module 212 can also be used to populate the database 216 with products and corresponding product information, including a threshold amount to be used in association with Extreme Value Listing. The threshold amount may comprise a cost associated with a product, an average selling price associated with a product, or any amount chosen to be associated with a product. The products and corresponding product information may be stored on a per-SKU basis, with the contents of the database 214 being used throughout the advertising and selling process.

The database 214 is a conventional type and is used to store data about specific goods, pricing, transaction and other information as will be understood to those skilled in the art. While the database 214 is shown for convenience and ease of understanding as part of the server 102, it should be recognized that the database could be a separate stand-alone system such as those provided by SAP, Oracle or other database companies and which communicates with server 102.

The compatibility reference files 218 include information about compatibility between items. The reference files can include any information that defines a relationship between two or more items. The compatibility reference files 218 are preferably a plurality of files one for each item with details such as: 1) manufacturer, 2) manufacturer identification number, 3) item number, 4) make, 5) make identification number, 6) model, 7) model identification number, 8) description of item, 9) list of compatible products, etc. The compatibility reference files 218 are created by the compatibility input module 204 based on input from the sellers or merchants. This information can be provide by direct input, downloading of files, or references to manufactures databases, or any various data importing mechanisms. Although shown as a separate element in FIG. 2, those skilled in the art will recognize that these files could be stored in the database 214.

The SKU compatibility files 220 are files with the compatibility information for a particular item in stock. The SKU number is used as an index to reference the file. The SKU compatibility files 220 are small individual files that have compatibility information for the particular item associated with the SKU. The SKU compatibility files 220 are generated from the compatibility reference files 218 by the input compatibility input module 204. Although shown as a separate element in FIG. 2, those skilled in the art will recognize that these files could be stored in the database 214.

The shipping module 230 enables integration with shipping provider(s) 242. The shipping module 230 interfaces with software systems of shipping provider(s) 242 via direct API integrations. Such shipping providers 242 may include organizations such as United Parcel Service (UPS), United States Postal Service (USPS), Federal Express and the like. These direct API integrations allow real-time shipping rates to be provided to buyers and sellers.

The communication module 232 enables a merchant to communicate to its customer(s), as well as for the customer(s) to communicate with the merchant. The communications module 232 includes an Extreme Value List notifier function in which a subset of customers is notified of a purchasing opportunity. Notification occurs upon conditions specified, including at least the current bid price (as in the case of an auction marketplace) being below the threshold amount at a given stage of the selling process (e.g., a defined time before the close of bidding). In some cases, the subset of customers may comprise the entire available set of customers. These communications may take any form, including that of email, instant messaging, Voice over Internet Protocol (VoIP) communications, and the like. These communications may include a way for the recipient customer to expeditiously access the product sale at issue (e.g., a link to the product sale webpage).

The customer record module 234 serves to store all customer information, such as customer names, addresses, payments, purchase history, demographics or the like. The customer record module 234 includes an Extreme Value List identifier function in which a subset of customer records is selected to construct an Extreme Value List. Selection of such a subset may be based on any number of factors or available classifications of customers. Customers may be classified according to demographics, purchasing patterns, and the like, based on available and determinable factors. In some instances, a merchant may choose to include all customers in the database 216 on the Extreme Value List.

The order management module 236 enables a merchant to manage the process of fulfilling orders. The order management module 236 can specifically designate orders to be charged (if using credit card payments or the like), identify those orders ready for shipping, and creating invoices and packing slips.

Referring now to FIG. 3, a block diagram of a second embodiment of the product compatibility system 102 of the present invention is shown. The product compatibility system 102 preferably comprises a control unit 350, a display device 310, a keyboard 312, a cursor control device 314, a network controller 316 and one or more input/output (I/O) device(s) 318.

Control unit 350 may comprise an arithmetic logic unit, a microprocessor, a general purpose computer, a personal digital assistant or some other information appliance equipped to provide electronic display signals to display device 310. In one embodiment, control unit 350 comprises a general purpose computer having a graphical user interface, which may be generated by, for example, a program written in Java running on top of an operating system like WINDOWS® or UNIX® based operating systems. In one embodiment, one or more application programs are executed by control unit 350 including, without limitation, word processing applications, electronic mail applications, financial applications, and web browser applications.

Still referring to FIG. 3, the control unit 350 is shown including processor 302, memory unit 304, and data storage device 306, all of which are communicatively coupled to system bus 308.

Processor 302 processes data signals and may comprise various computing architectures including a complex instruction set computer (CISC) architecture, a reduced instruction set computer (RISC) architecture, or an architecture implementing a combination of instruction sets. Although only a single processor is shown in FIG. 3, multiple processors may be included.

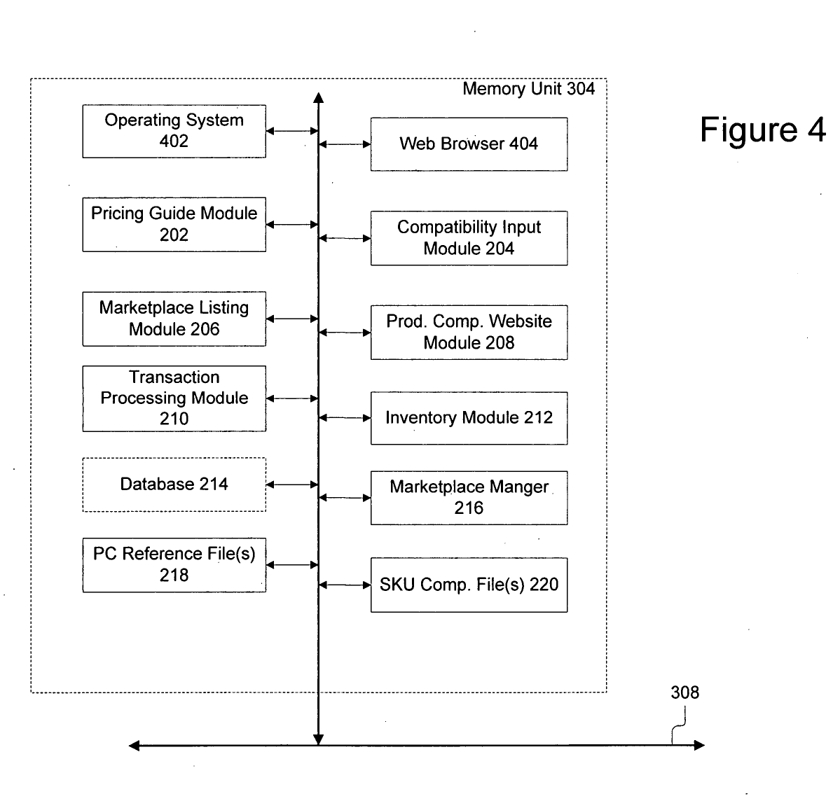

Memory unit 304 stores instructions and/or data that may be executed by processor 302. The instructions and/or data may comprise code for performing any and/or all of the techniques described herein. Memory unit 304 may be a dynamic random access memory (DRAM) device, a static random access memory (SRAM) device, or some other memory device known in the art. The memory 304 is described in more detail below with reference to FIG. 4.

Data storage device 306 stores data and instructions for processor 302 and comprises one or more devices including a hard disk drive, a floppy disk drive, a CD-ROM device, a DVD-ROM device, a DVD-RAM device, a DVD-RW device, a flash memory device, or some other mass storage device known in the art.

System bus 308 represents a shared bus for communicating information and data throughout control unit 350. System bus 308 may represent one or more buses including an industry standard architecture (ISA) bus, a peripheral component interconnect (PCI) bus, a universal serial bus (USB), or some other bus known in the art to provide similar functionality. Additional components coupled to control unit 350 through system bus 308 include the display device 310, the keyboard 312, the cursor control device 314, the network controller 316 and the I/O device(s) 318.

Display device 310 represents any device equipped to display electronic images and data as described herein. Display device 310 may be, for example, a cathode ray tube (CRT), liquid crystal display (LCD), or any other similarly equipped display device, screen, or monitor. In one embodiment, display device 310 may be equipped with a touch screen in which a touch-sensitive, transparent panel covers the screen of display device 310.

Keyboard 312 represents an alphanumeric input device coupled to control unit 350 to communicate information and command selections to processor 302. The Keyboard 312 can be a QWERTY keyboard, a key pad, or representations of such created on a touch screen.

Cursor control 314 represents a user input device equipped to communicate positional data as well as command selections to processor 302. Cursor control 314 may include a mouse, a trackball, a stylus, a pen, a touch screen, cursor direction keys, or other mechanisms to cause movement of a cursor.

Network controller 316 links control unit 350 to a network 104 that may include multiple processing systems and client devices 106a-n. The network 104 of processing systems may comprise a local area network (LAN), a wide area network (WAN) (e.g., the Internet), and/or any other interconnected data path across which multiple devices may communicate. The control unit 350 also has other conventional connections to other systems such as a network for distribution of files (media objects) using standard network protocols such as TCP/IP, http, https, and SMTP as will be understood to those skilled in the art.

One or more I/O devices 318 are coupled to the system bus 308. For example, the I/O device 318 includes an image scanner and document feeder for capturing an image of a document. The I/O device 318 also includes a printer for generating documents. The I/O device 318 may also include audio input/output device equipped to receive audio input via a microphone and transmit audio output via speakers. In one embodiment, audio device is a general purpose; audio add-in/expansion card designed for use within a general purpose computer system. Optionally, I/O audio device may contain one or more analog-to-digital or digital-to-analog converters, and/or one or more digital signal processors to facilitate audio processing.

It should be apparent to one skilled in the art that product compatibility system 102 may include more or less components than those shown in FIG. 3 without departing from the spirit and scope of the present invention. For example, product compatibility system 102 may include additional memory, such as, for example, a first or second level cache, or one or more application specific integrated circuits (ASICs). Similarly, additional components input/output devices 318 may be coupled to control unit 350 including, for example, an RFID tag reader, digital still or video cameras, or other devices that may or may not be equipped to capture and/or download electronic data to control unit 350. One or more components could also be eliminated such as cursor control 314.

FIG. 4 is a block diagram of one embodiment of the memory unit 304 for the product compatibility system 102. The memory unit 304 for the product compatibility system 102 preferably comprises: an operating system 402, a web browser 404, the pricing guide module 202, the compatibility input module 204, the listing module 206, the product compatibility website module 208, the transaction processing module 210, the inventory module 212, the database 214, the marketplace manager 216, compatibility reference files 218, and a SKU compatibility file 220. As noted above, the memory unit 304 stores instructions and/or data that may be executed by processor 302. The instructions and/or data may comprise code for performing any and/or all of the techniques described herein. These modules 402, 404, 202-220 are coupled by bus 308 to the processor 302 for communication and cooperation to provide the product compatibility system 102. Those skilled in the art will recognized that while the present invention will now be described as modules or portions of a memory unit 304 of a computer system, the modules or portions may also be stored in other media such as permanent data storage device 306 and may be distributed across a network 104 having a plurality of different computers such as in a client/server environment.

The operating system 402 is preferably one of a conventional type such as, WINDOWS®, SOLARIS® or LINUX® based operating systems. Although not shown, the memory unit 304 may also include one or more application programs including, without limitation, word processing applications, electronic mail applications, financial applications, and web browser applications.

The function and operation of the pricing guide module 202, the compatibility input module 204, the listing module 206, the product compatibility website module 208, the transaction processing module 210, the inventory module 212, the database 214, the marketplace manager 216, compatibility reference files 218, and a SKU compatibility file 220 were described above so that description will not be repeated here. Moreover, the operation of these modules in one embodiment is described in co-pending U.S. patent application Ser. No. 11/212,515, filed on Aug. 24, 2005, entitled “Systems And Methods For Online Trade-In Of Goods,” which is incorporated herein by reference. It should be noted that each of these modules 202-216 are coupled to the bus 308 for communication with each other and the processor 302. Such a coupling allows the modules to perform the methods described below with reference to FIGS. 5-6B.

General Method

Referring now FIG. 5, the general method for performing a product compatibility transaction in an online environment in accordance with the present invention will be described. At a general level, the method of the present invention has three major stages that can be separate in time. These three major stages include: 1) preparation of the website for presentation of compatibility information and updating one or more listings to include the compatibility information; 2) user interaction with the product compatibility system 102 to find compatible items and select them for purchase; and 3) processing of the transaction to purchase the compatible item. As shown in FIG. 5, method begins in step 502 with compatibility information been input into the system 102. Once the compatibility information has been input into the system 102, the system 102 creates 504 compatibility files. For example, the input can be used to populate reference files 218 that can be shared amongst users. These reference files 218 in turn can be used to create SKU compatibility files 220. An SKU compatibility file 220 is a data file that can be added to a listing for an online marketplace. The SKU compatibility file 220 includes compatibility information specific to the listing with which it is associated. Next, the method of the present invention inserts 506 the compatibility file 220 into an online marketplace listing. Those skilled in the art will recognize that this process may be repeated for any number of items. Moreover, those skilled in the art will further understand that this process may be automated for updating multiple listings with corresponding compatibility files 220 by matching the SKU number used for the listing and the compatibility file 220. Next, the system 102 receives 508 information from the user regarding an item and its compatibility. For example, a user could input the manufacturer, to make, and the model of a computer for which the user is seeking compatible products. Using the input provided by the user, the system 102 searches 510 for listings with compatibility information/files 220 that match the criteria input by the user. The listings produced by the search 510 are displayed 512 to the user. For example, the system 102 sends the listings and other information over the network 104 for display on the client device 106. In addition, the system 102 displays 514 purchasing options and using a Web browser and the user can complete the transaction to purchase any one or more of the items displayed. The present invention is particularly advantageous because it provides a user with the simple and effective tool to find items that are useful in conjunction with other items the user already has or is in the process of purchasing. While the present invention has been described above as a stand-alone method, those skilled in the art will recognize that the present invention could be combined with other automation tools such that when the user has selected item for purchase, such as placing the item in the user's shopping cart, the system 102 will automatically search for and display to the user other items that are compatible with the item in the user's shopping cart. Furthermore, those skilled in the art will recognize that if profiles are maintained for users, such as for their past purchases, or profiles input by the user listing items that they currently use or own, the system 102 could automatically run the product compatibility process described above on all items listed in the user profile, and present lists of items that the user may be interested in purchasing.

Example Method

Referring now to FIGS. 6A and 6B, a second embodiment of a method for finding, presenting and selling compatible products in an online marketplace according to the present invention will be described. In particular, FIG. 6 illustrates the process steps as performed by the server 102 and the client device 106 or user. Furthermore, it should be understood that the method of FIGS. 6A and 6B is described in the context of an online marketplace such as that provided by eBay; however, the principles of the present invention are applicable to any variety of systems to find and present compatible items. Referring now to FIG. 6A, the process begins in step 602 with a SKU and other data for an item being input into a database 214, such as that provided by Infopia of Salt Lake City, Utah. This step is performed in the conventional manner as is commonly done for sellers that have coupled their company database to enable the listing and sale of items in an online marketplace. This step may be performed manually with human users inputting data into a database, or semi-automatically with data being uploaded to a database from any type of file. Next, compatibility data is input 604 into the database 214. By way of example, compatibility data may be input using reference files of data provided by manufacturers or other third parties that specify the compatibility of a particular product with other products. Still more particularly, the input compatibility data may be reference files 218 as have been described above. This is particularly advantageous because it allows sellers who have a significant number of listings to provide all the compatibility information in the same database 214 as used for generating their listings. In other words, a single database used to track inventory and generate listings for the online marketplace can also be used to store the compatibility information. Using the input compatibility data from step 604, the process continues by creating 606 an SKU compatibility file. The SKU compatibility file 220 has been described above. Next, the server 102 launches an item listing. This entails creating a listing for online marketplace including product information, model number, the description, photos, and any other information; and uploading it to an online marketplace. This is done in the conventional manner as commonly performed by users in posting items for sale, such as on eBay. The server 102 augments the listing by inserting a product compatibility file (PCF). The product compatibility file is an instance of the SKU compatibility file 220 specific to the item being listed. The complete listing including the product compatibility file is then made available 612 in the online marketplace.

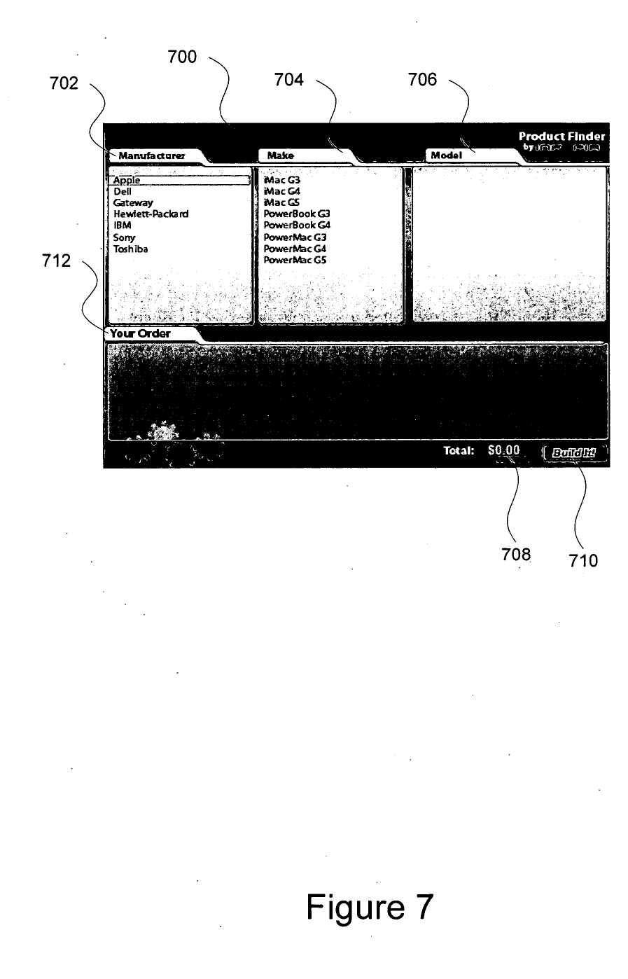

Once a listing with compatibility information has been made available on the online marketplace, any number of users may interact with that listing. In one embodiment, the user at the client device 106 selects 614 the product compatibility tool. In one embodiment, this is a Macromedia Flash application that implements the user interfaces and process that will be described below. In response, the client device 106 displays a product compatibility interface 700 (described in more detail below with reference to FIGS. 7-9). Using the product compatibility interface 700, the user inputs or selects 618 a first category or criteria of the product for which compatible items are sought. For example, in the user interface of FIG. 7, this first category is a manufacturer type. The first category input by the user is sent by the client device 106 to the server 102. The server 102 then searches 620 listings using the first category input. More specifically, the server 102 searches the product compatibility file portions of the listings to determine which listings match the first category input. Then the server 102 sends 622 the results of the search to the client device 106. The client device 106 displays an updated product compatibility interface that includes matches in the first category, and available products with the same category. An example of such an interface is shown in FIG. 7.

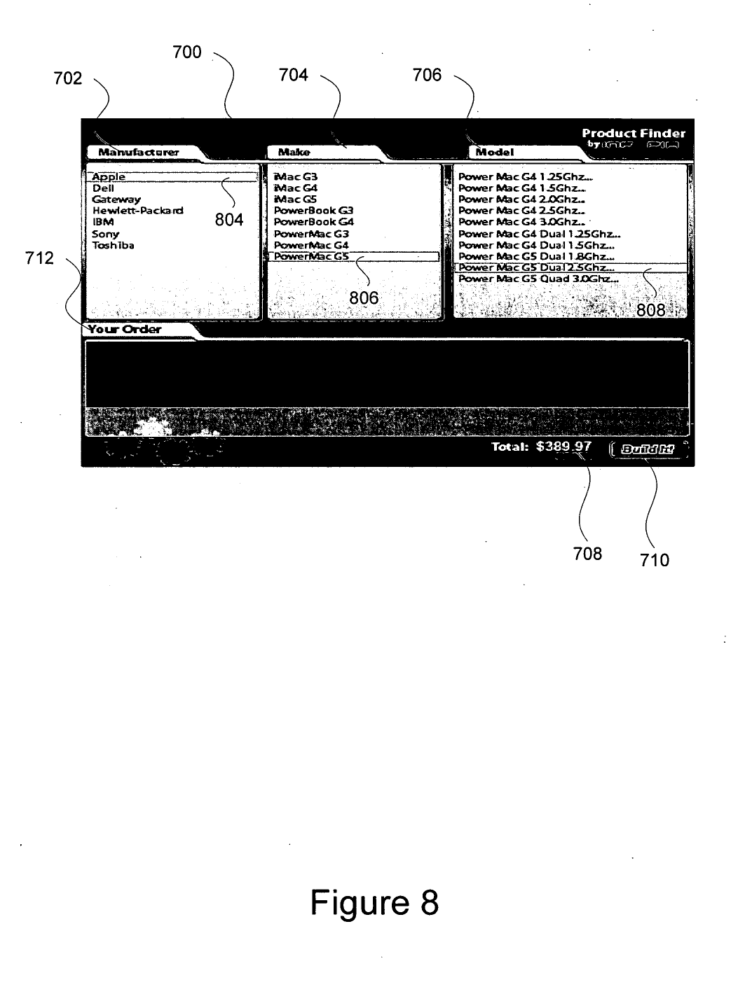

Referring now also to FIG. 6B, the process continues with the user selecting 626 a second category. For example, the second category could be the make of product. The input from the user in step 626 is then sent by the client device 106 to the server 102. The server 102 refines 628 the listings using the second category input. The refined results are then sent 630 to the client device 106. The client device 106 again generates 632 an updated display using the results sent in step 630. An example of an updated user interface is shown in FIG. 8.

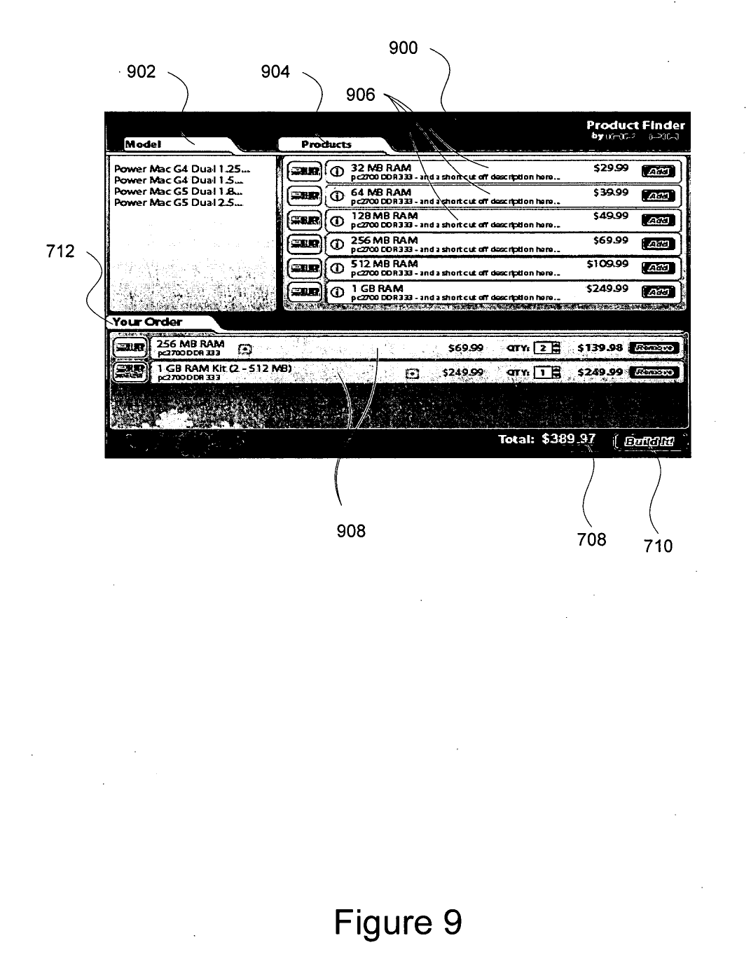

Next, the process continues with the user selecting 634 a third category. For example, the third category could be a specific product. Once again, the input from the user is sent by the client device 106 to the server 102, and the server 102 refines 636 the listings using the third category input. The results from the second refining step 636 are sent 638 to the client device 106, and displayed 640 in an updated product configuration interface. An example of such an interface is shown in FIG. 9.

Those skilled in the art will recognize that the above description of searching, refining, and presenting compatible items was described in the context of looking for products compatible with a computer, and the criteria were manufacturer make, and model for computers. Those skilled in the art will recognize that there may be any number of categories from one to n that define items moving from a general to a specific to narrow the number of items returned. For example, in the context of automobiles, the categories and levels of information sought from the user could include: make, model, year, price, location, and options.

Still referring to FIG. 6B, while the updated product compatibility interface of FIG. 9 is displayed, the user can order any one of the products displayed by selecting the add button. The user adds 642 any desired items, and the display is updated to show those items in an ordered section. Then the user selects 644 the “build it” button to indicate that the user is interest in purchasing the items in your section. In response to selection of the “build it” button, control is returned to the server 102, and the server 102 creates 646 a new product listing using the items chosen by the user. The server 102 then redirects 648 the user to the new listing that is just been created. The user completes 650 the transaction by accepting the new listing. The user can then check out in a conventional manner such as using a shopping cart metaphor and providing the server with information such as payment data, shipping data, identification data and other data necessary to the complete the transaction. The process then is handed back to the server 102 which creates 654 an invoice. Finally, the server 102 processes 656 the payment and send the item to the buyer in a conventional manner.

User Interfaces

FIG. 7 is a graphical representation of an exemplary user interface for inputting data regarding compatibility according to the present invention. The user interface 700 preferably includes a window divided into several regions. The exemplary user interface has three categories for the user to provide increased levels of specificity for the types of compatible products the user is searching for. As can be seen, a first region 702 has a label indicating a manufacturer and presents a variety of manufacturers for which products are listed. The second region 704 provides the different makes of goods corresponding to the manufacturers in the first region 702. A third region 706 provides an area for displaying models corresponding to makes manufacturers that have been input or selected by the user. A fourth portion of the window 700 provides an area 712 in which products that have been ordered by the user can be displayed. The user interface 700 also includes information such as a total price for the products in the order section 712, and a button 710 labeled build it which will create a listing including all the products with in the order section 712 in response to user selection of the button 710. The user interface of FIG. 7 corresponds to the display step 616 of the method of FIG. 6A.

Referring now to FIG. 8, a graphical representation of the exemplary interface for inputting compatibility data, finding compatible goods and displaying an order of compatible goods is shown. The user interface shown in FIG. 8 is similar to that of FIG. 7, and like reference numerals have been used to delineate similar portions of the user interface. FIG. 8 illustrates the user interface 700 including additional data that has been provided by the system. 102 in response to user input of a manufacturer and make. As highlighted in the upper sections 702, 704 and 706, the user has selected a manufacturer 802 in the first area 702, and a make 806 in the second area 704. As has been described above, each of the displayed alternatives in each of the areas 702, 704 and 706 are provided by the server 102 based on a combination of compatible listings and user selection within the areas 702, 704 and 706. The user interface of FIG. 8 corresponds to the display steps 624 and 632 of the method of FIGS. 6A. and 6B.

Referring now to FIG. 9, a graphical representation of another exemplary interface for inputting compatibility data, and ordering compatible goods according to the present invention is shown. The user interface 900 shown in FIG. 9 is similar to that of FIGS. 7 and 8, and like reference numerals have been used to delineate similar portions of the user interface. This embodiment of the user interface 900 has a first region 902 similar to the third region 706 of the prior user interfaces. This region is used to display models with which the listed products will be compatible. A second region 904 provides a list of items 906 that are available for purchase in the online marketplace. Each of the items 906 listed includes information about that product such as a short description, a price, a seller, and a button 910 that responsive to user selection that will add the item to the users order and update the order portion 712 of the user interface 900. FIG. 9 also illustrates how selected items 908 are displayed in the order portion 712 of the user interface. Once the build it button 710 is selected by the user, the items listed in the order portion 712 will be combined into a new-product listing, which the user can confirm it is interested in purchasing and consummate the transaction.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats. Furthermore, as will be apparent to one of ordinary skill in the relevant art, the modules, routines, features, attributes, methodologies and other aspects of the present invention can be implemented as software, hardware, firmware or any combination of the three. Of course, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

What is claimed is:

1. A computer implemented method for selling an item based on product compatibility, the method comprising:
inserting input compatibility information as part of a listing for an on-line marketplace;
receiving user input regarding a first compatibility criterion;
searching the on-line marketplace for a listing that matches the first compatibility criterion; and
displaying at least one match to the first compatibility criterion and a corresponding listing.

2. The method of claim 1 further comprising the step of inputting compatibility information.

3. The method of claim 1 wherein the step of inputting compatibility information includes inputting compatibility information into a database accessible to the on-line marketplace.

4. The method of claim 1 further comprising the step of creating a compatibility file using input compatibility information, and wherein the step of inserting is attaching the compatibility file as part of the listing.

5. The method of claim 1 wherein the step of creating a compatibility file creates a SKU specific compatibility file from a reference file.

6. The method of claim 1 further comprising the steps of:
displaying a purchase option for the match to the first compatibility criterion and a corresponding listing; and
completing a transaction for the purchase of the item in the corresponding listing.

7. The method of claim 1 further comprising the steps of:
receiving user input regarding a second compatibility criterion;
searching the on-line marketplace for a listing that matches the first compatibility criterion and the second compatibility criterion; and
displaying a match to the first compatibility criterion, a match to the second compatibility criterion and a corresponding listing.

8. The method of claim 1 further comprising the steps of:
receiving user input regarding a second compatibility criterion;
refining the listings that matches the first compatibility criterion to select those that also match the second compatibility criterion; and
updating a user interface to display at least one listing produced by the refining step.

9. The method of claim 7 further comprising the steps of:
receiving user input regarding a plurality of additional compatibility criteria;
searching the on-line marketplace for a listing that matches the first compatibility criterion, the second compatibility criterion and the plurality of additional compatibility criteria; and
displaying a match to the first compatibility criterion, a match to the second compatibility criterion, a match to the plurality of additional compatibility criteria and a corresponding listing.

10. The method of claim 1 further comprising the steps of:
receiving user input selecting a item in a listing for purchase;
creating a new product listing including one or more items selected by the user;
re-directing the user to the new product listing; and
completing a transaction using the new product listing.

11. The method of claim 6 wherein completing a transaction for the purchase of the item further comprises:
checking out using a shopping cart interface;
creating an invoice for the item;
processing payment for the item, and
sending the item to the user.

12. A system for suggesting items for a user to purchase based on the compatibility of the items, the system comprising:
a marketplace manager having an input and an output for facilitating and managing a sale of items, the managing product compatibility location and presentation process;
a listing module having an input and an output for presenting an item and related information including compatibility to the user, the input of the listing module coupled to the marketplace manager; and
a product compatibility module having an input and an output for searching and displaying items compatible with an input parameter, input and output of the product compatibility module coupled to the listing module and the marketplace manager.

13. The system of claim 12 further comprising a transaction module having an input and an output for accepting input from the user and completing a transaction to purchase a compatible item, the input of the transaction module coupled to receive input from the user, the listing module, and the marketplace manager.

14. The system of claim 12 wherein the product compatibility module creates a customer facing website that allows users to view items compatible with the input parameter and purchase compatible items.

15. The system of claim 12 wherein the product compatibility module receives a first parameter on compatibility from a user, searches listings matching the first parameter, and displays a plurality of second parameters for compatibility.

16. The system of claim 12 wherein the product compatibility module presents user interfaces and data, perform searches and filtering responsive to user input of compatibility criteria.

17. The system of claim 12 further comprising a compatibility input module having and input and an output, the input of the compatibility input module coupled to receive compatibility data from a user, the output of the compatibility input module coupled to the listing module, the compatibility input module providing compatibility data used to augment one or more listings.

18. The system of claim 17 wherein the compatibility input module generate a SKU compatibility file that the listing module adds to the listing.

19. The system of claim 17, wherein the system further comprises a database and wherein the compatibility input module receives compatibility data from a user and stores it in the database.

20. The system of claim 12 further comprising a database including a compatibility reference file that includes information about compatibility between items.

21. The system of claim 20 wherein the compatibility reference files includes at least two from the group of: 1) manufacturer, 2) manufacturer identification number, 3) item number, 4) make, 5) make identification number, 6) model, 7) model identification number, 8) description of item, and 9) list of compatible products.

22. The system of claim 12 wherein the product compatibility module receives and processes a plurality of compatibility parameters from the user.

23. The system of claim 13 wherein the transaction module receives a list of compatible items from the user, creates a new product listing from the list of compatible items and after receiving confirmation from the user, is adapted to complete a transaction for the sale of the list of compatible items.
